(19) United States
(12) Patent Application Publication
(10) Pub. No.: US 2006/0072742 A1
(43) Pub. Date: Apr. 6, 2006

(54) Magnetic hook switch

(76) Inventors: Scott E. Seay, Cumming, GA (US); Darrell L. Eddings, Alpharetta, GA (US)

Correspondence Address: US CORPORATIONS, INC., 630 NEPTUNE AVE., ENCINITAS, CA, 92024, US

(21) Appl. No.: 10/685,642

(22) Filed: Oct. 15, 2003

(51) Int. Cl. H04M 1/00

(52) U.S. Cl. 379/424

(57) ABSTRACT

A telephone magnetic hook switch board mounted within a handset cradle of the communications device. The device magnetic circuits place the communications station on-hook or off-hook, depending on the amount of ambient magnetic flux. The magnetic flux varies with the presence or absence of a handset in the cradle. If the handset and the is removed from the cradle, the circuit will change state and the telephone and will go off-hook.

### CROSS-REFERENCE TO RELATED APPLICATION

This application relies on a previously filed provisional application.

### STATEMENT REGARDING FEDERALLY SPONSORED RESEARCH OR

### DEVELOPMENT

Not applicable

### REFERENCE TO SEQUENCE LISTING

Not applicable

### BACKGROUND

Electro-mechanical switches, micro p switches, and magnetic hook switches have been used for many years to place a telephone on hook or off hook. Historically a mechanical plunger or tongue assembly has been used to activate the switch. In other instances a secondary magnet placed in the telephone handset handle or other location has been used for this purpose. This new method of operation will eliminate the need for the tongue assembly and/or any other additional magnets to activate the switch and operate the telephone. The existing telephone handset will be used. In addition to the removal of a moving mechanical part that was subject to malfunction and abuse by the users of the telephone, a large opening in the telephone housing can be eliminated. Elimination of the tongue assembly mounting hole in the telephone housing will significantly reduce the amount of moisture, cleaning fluids, and other liquids that previously would have entered the housing through the opening. The result will be a significant reduction in maintenance expense.

When the parties have completed their conversation, they must hang up the handset. Examples of known distributed audio systems are disclosed in U.S. Pat. No. 4,847,888 to Cox et al., U.S. Pat. No. 5,014,347 to Cox et al., U.S. Pat. No. 4,206,318 to Steely, U.S. Pat. No. 5,179,588 to Nowicki, U. S. Pat. No. 5,559,625 to Smith et al., and U.S. Pat. No. 5,033,080 to Deane.

For existing communications stations, on-hook/off-hook switching is accomplished using mechanical switches. For example, when the handset of a communications station is placed off-hook, a mechanical switch is activated to connect the telephone to the line. Such mechanical switches can be unreliable, large in size and expensive. Additionally, mechanical switches are generally exposed to environmental contaminants, for example, particulates or gases, which can corrode the mechanical switching mechanism and contacts. Other examples of harsh environmental conditions include exposure to moisture, corrosive vapors such as industrial chemicals or salt air, temperature extremes, particulates, radiation, electrical fields, stray magnetic fields, and the like. When exposed to these types of environments, the mechanical switches may corrode, become encrusted or otherwise become inoperable.

Alternatively, non-contact, reed switches have been used. The non-contact means are generally costly, more susceptible to stray electromagnetic fields, and less robust than mechanical or magnetic switches.

Thus, there is a need for improved communications stations having reliable on-hook and off-hook magnetic switches that are small in size, low in cost and able to withstand harsh environmental conditions, and therefore are not susceptible to the corrosion of the contacts or weak stray magnetic fields.

### DETAILED DESCRIPTION OF THE INVENTION

Accordingly, an aspect of the present invention is a communications device having reliable magnetic on-hook and off-hook switches that can withstand harsh environments. A communications station such as a telephone has a handset support cradle which need not be physically a part of or connected to the body of the telephone. The handset support cradle can be disposed alongside the telephone body, or in the general proximity of the telephone body. This facilitates rapid replacement of components if necessary. A hook-switch board is preferably a part of the handset support cradle, and is electrically connected to the circuitry of the telephone.

In accordance with another aspect of the present invention, a communications device comprises an integrated magnetic circuit for on-hook and off-hook switching.

In accordance with yet another aspect of the present invention, a telephone is provided for use in a distributed audio system. The field telephone comprises a handset connected to a main telephone body. The handset generates a magnetic field caused by leakage flux from a magnet. A handset support cradle is attached to the telephone body and comprises a hook-switch board having an integrated circuit which reacts with the magnetic field when the handset is placed in the handset support cradle. The magnetic field affects the integrated circuit to place the telephone in an on-hook state. Similarly, when the handset is removed from the handset support cradle, the magnetic field is removed from the circuit, and the telephone enters an off-hook state. The magnet can be a component of a receiver contained within the handset, or a separate component attached to the handset.

Other advantages and salient features of the invention will become apparent from the following detailed description, which, when taken in conjunction with the annexed drawings, discloses preferred embodiments of the present invention.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and. scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention

We claim:

1. In combination with a telephone, magnetic hooks switch to for the purpose of engaging or disengaging telephone operations through off-hook and on-hook operations.

2. Magnetic hook switch, according to claim 1, wherein the switching device is controlled with a circuit board powered by the telephone operating system.

3. A Magnetic hook switch, according to claim 1, wherein the switching device is controlled with a circuit board powered by a portable, rechargeable operating system.

4. A Magnetic hook switch, according to claim 1, wherein the switching device replaces the plunger or tongue assembly.

5. A Magnetic hook switch, according to claim 1, wherein the switching device is controlled magnetically replacing the tongue assembly.

6. Separate from a telephone, a magnetic hook switch to for the purpose of engaging or disengaging telephone operations through off-hook and on-hook operations.

7. Magnetic hook switch, according to claim 6, wherein the switching device is controlled with a circuit board powered by the telephone operating system.

8. Magnetic hook switch, according to claim 6, wherein the switching device is controlled with a circuit board powered by a portable, rechargeable operating device.

9. A Magnetic hook switch, according to claim 6, wherein the switching device replaces the plunger or tongue assembly.
